(19) United States
(12) Patent Application Publication
(10) Pub. No.: US 2019/0387686 A1
(43) Pub. Date: Dec. 26, 2019

(54) Single Source High Wattage LED Chip Grow Light Fixture - 100W Chip & Greater

(71) Applicant: Scott McCormick, Las Vegas, NV (US)

(72) Inventor: Scott McCormick, Las Vegas, NV (US)

(21) Appl. No.: 15/874,643

(22) Filed: Jan. 18, 2018

(51) Int. Cl. A01G 7/04; F21V 29/71; F21V 29/503; F21V 23/00

(52) U.S. Cl. CPC A01G 7/045; F21V 29/71; F21Y 2115/10; F21V 23/002; F21V 23/005; F21V 29/503

(57) ABSTRACT

A single source high wattage LED chip (100 W and greater) inside an agricultural grow light fixture housing is disclosed. This invention uses a single source high wattage LED chip, in contrast to current grow lights utilizing multiple small and low wattage LED chips. The single source high wattage LED chip design provides tremendously more intensity, provides or greater energy and delivers a higher number of photons per square meter than current agricultural grow lights. The design is directly related to better plant penetration to stimulate the photosynthesis process for sustainable healthy growth and flowering by creating a larger light source surface area. The mathematics and science state the surface area of the light source is directly related to the intensity and energy produced per square meter.

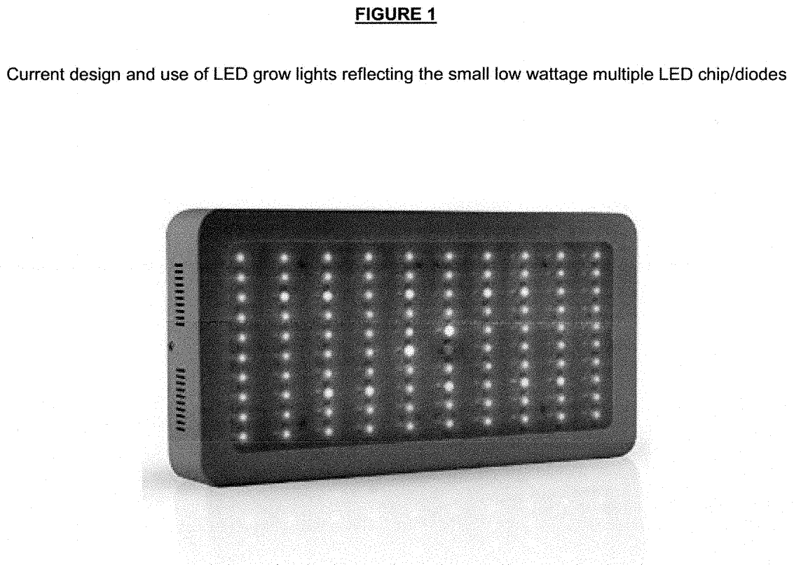

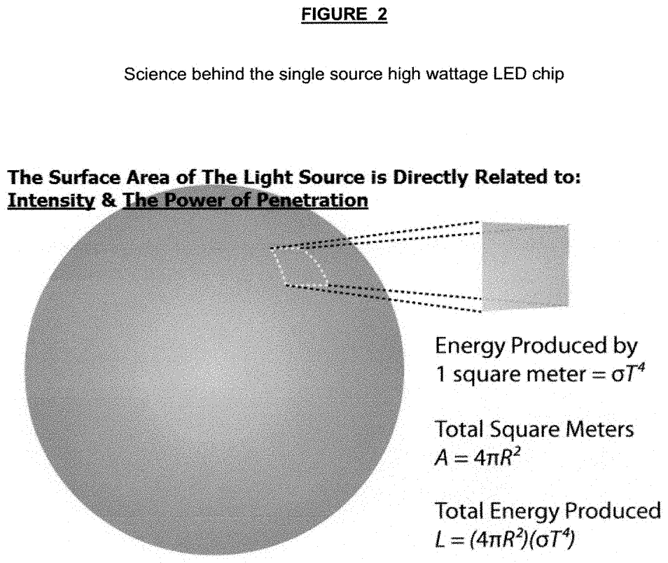

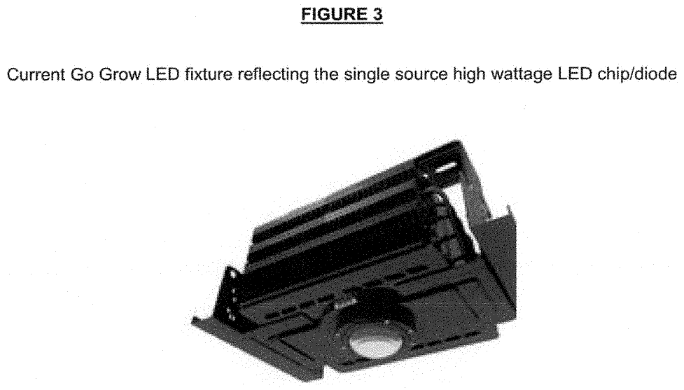

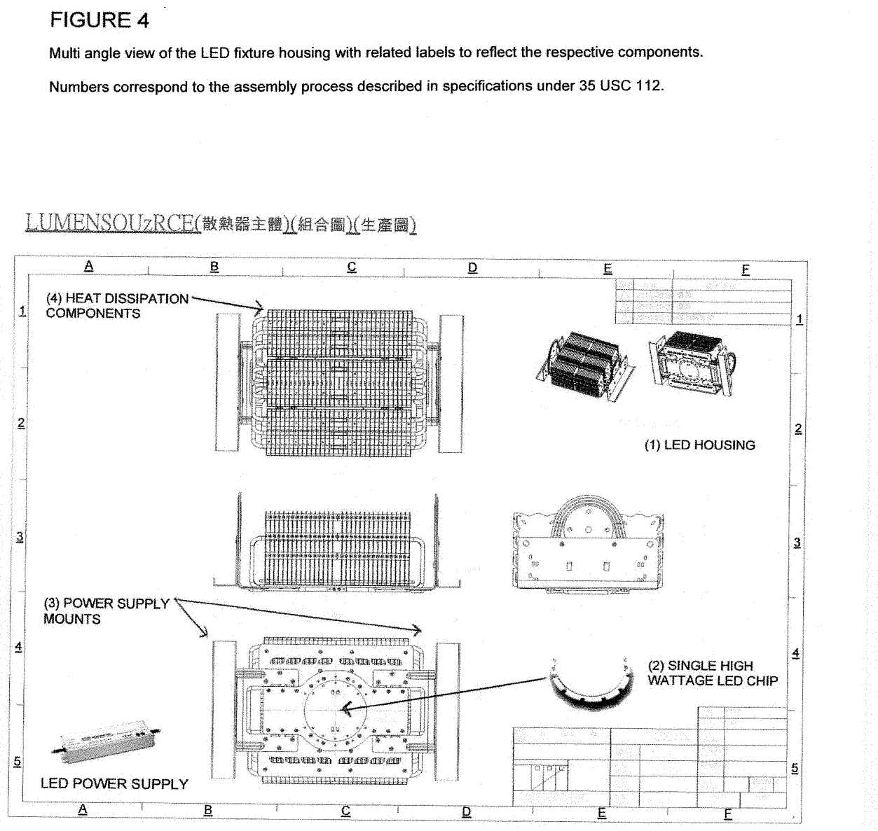

### DETAILED DESCRIPTION OF THE INVENTION

The Go Grow LED Agricultural Grow Light is an entirely new design for these types of fixtures and applications. The invention utilizes a single source high wattage (100 W and greater) LED chip which is housed in an agricultural grow light fixture housing with advanced cooling components and light optics. This single source high wattage LED design creates more intensity, a larger number of photons, and greater energy than current agricultural grow lights. The larger surface of the light source gives the grow light the ability to produce a more healthy, abundant and sustainable plant, fruit, vegetable, or livestock. Additionally, because so much energy is produced, when compared to current grow lights utilizing multiple small and low wattage LED's, this invention can be mounted much higher off the plants canopy and continue to promote the photosynthesis process at greater rates.

The invention and use of the single source high wattage chip is not currently being designed or used by agricultural grow light manufacturers primarily due to the lack of R&D as it relates to the dissipation of the heat away from the LED chip. Along with the single source high wattage LED chip, comes a tremendous amount of heat in a matter of seconds, whereby the use of multiple smaller and low wattage chips generally do not emit much heat so cooling components and technology are not needed. Adding to the barrier for the invention's design is the cost of the finished product. Most manufacturers are looking to capitalize with the largest profit margins possible, so using inexpensive small LED chips that do not require much heat dissipation technology is the best design, even thought this design is flawed by nature. The invention by Go Grow LED combines the best of math and science to create a grow light fixture that is superior in all aspects, except profit margins. That being said, this invention was not designed with profit margins in mind but rather how to create an LED grow light that actually grows and produces results—how the fix the LED grow light flaw.

Research and development proved the larger the light source, the more intensity and energy will be produced. This is a concept you will read throughout this application is this is the scientific foundation that created the invention we are looking to patent. Like the Earth has a single large sun, indoor grow facilities, greenhouses, vertical indoor farms and even livestock can benefit from a large single high wattage, intense, powerful LED grow light.

### PROBLEM SOLVED

The current design of Agricultural LED Grow Lights lack the light intensity, related delivered photons (PPF—photosynthetic photon flux and PPDF photosynthetic photon flux density) and energy from the LED light source (LED diodes/chips—herein referred to as “LED's”) to promote healthy and sustainable growth, vegetation and flowering. Current design of LED grow lights utilize numerous small (1 W-10 W) LED's on a flat panel surface in order to create a high wattage (100 W or greater) fixture (IMAGE 1).

The primary flaw/problem in this design is the small LED's can only deliver the intensity, photons, and energy of that individual single low wattage LED, no matter how many you place on the panel. These small LED's provide poor penetration of the plants, at a cellular level, to stimulate photosynthesis for sustainable growth and flowering. Science and math prove, the surface area of the light source is directly related to the intensity and the energy produced per square meter (IMAGE 2).

Traditional grow lights utilize High Intensity Discharge lights bulbs know as Metal Halides and High Pressure Sodium. The problem with this type of light is the high energy consumption, typically 1000 W per light, and tremendous heat from the lamps. Current LED's attempted to solve these initial problem with HID lamps, however, lost sight of the design. By looking solely at reducing wattage and heat, manufacturers designed the most cost effective fixtures possible. And while current LED's do reduce energy consumption and cooling demands, the design does not support healthy and sustainable growth throughout all cycles. The traditional HID lamps maintained the single source high wattage design and to this day still work very effectively for growing. This invention takes LED to the next step.

The Go Grow LED Agricultural Grow Light invention utilizes a single source high wattage (100 W and greater) LED diode/chip design, in contrast to the traditional multiple low wattage LED's, in order to provide a much larger surface area light source; thereby, providing significantly greater intensity, increased photons being delivered and more energy being produced per square meter to promote healthy and sustainable growth at all stages (IMAGE 3).

The invention claimed here solves this problem.

Multiple low wattage chip LED grow light fixtures have difficulty promoting and/or maintaining healthy growth due to the lack of light intensity, photons being delivered and total energy produced per square meter due to the small light source; the low wattage LED's being utilized on the panels or surface area must be mounted inches above the plants canopy in order to be effective in any capacity and thereby also creating an extremely small light coverage footprint. Bottom line is the current design of LED's do not work very well.

The claimed invention differs from what currently exists.

Currently, small wattage (1 W-10 W) multi chip LED light source (see image 2 above) is the design being utilized by Agricultural Grow Light Manufacturers. The Go Grow LED utilizes a single source high wattage LED chip design to create a larger light source surface area which is mathematically more intense and produces more energy per square meter (IMAGE 3).

This invention is an improvement on what currently exists.

By utilizing a single high wattage light source in the Agricultural LED Grow Light, Go Grow LED has essentially replicated the same design as the Earth's Sun, delivering much more intensity, photons, and energy per square meter than the current LED Agricultural Grow Lights. Consider this—would plant life be the same if the Earth had numerous small Suns rather than its single and powerful Sun it has today? The answer is no because the low intensity, low number of photons produced and low energy from the small Suns would not be powerful enough to project to the Earth or promote healthy and sustainable growth (see image 1 above). The small Suns would need to be much closer in proximity to the Earth that it is today—the same concept holds true with LED agricultural grow lights. This invention uses a single source high wattage LED chip which is tremendously intense, more powerful and provides the photons and light needed for plant penetration to stimulate photosynthesis and healthy growth.

### The Version of The Invention Discussed Here Includes

1. Housing

2. Heat Dissipation Elements (Active & Passive)

3. Single High Wattage LED Chip

4. LED Driver

### How The Invention Works

The single high wattage LED chip is the key component to this invention. No LED grow light in the agricultural industry utilizes this design or technology. The single high wattage chip is secured in the fixture housing, powered by the LED driver and cooled by the heat dissipation elements. By having the high wattage single source LED, it creates a large surface area from which the light is produced which creates, by design, greater light intensity, a large number of photons and more energy.

### How To Make The Invention

The housing is fabricated from an aluminum material and is the basic structure of the light. The other components, LED chip, power supply and heat dissipation, are mounted to and inside the housing. The single source high wattage LED chip is the unique and different design used solely and specifically by the Go Grow LED fixtures. The LED chip is mounted to the housing, which is then connected to the heat dissipation elements to provide proper cooling of the single chip. The LED driver is then connected to the LED chip to provide its power source.

### How To Use The Invention

This invention can be used for indoor agricultural grow facilities, vertical farming, greenhouses, livestock, or personal residences, to grow plants, fruits, vegetables, livestock in a more efficient manner providing for increased light quality as it relates to PPF, PPFD and overall energy for sustainable life and health.

1. The Go Grow LED fixtures are the only LED grow light fixtures that use the single high wattage chip design. The use of this single high wattage LED chip design improves upon existing LED grow lights which use numerous small low wattage LED chips. By using the single high wattage LED chip, the Go Grow LED fixtures are capable of producing more energy and photons from the light source to better stimulate the photosynthesis process and provide healthy growth. Science states, the surface area of the light source is directly related to the energy produced per square meter. As such, having a much larger light source, the single high wattage LED chip, the Go Grow fixtures do in fact produce more energy per square meter than smaller LED chips. As previously specified as an example to illustrate the differences; ask yourself if plant life on Earth would be as abundant and healthy if it had a hundred small Suns rather than the single large Sun it has today. The answer is no as science and math have proven (see formula below). The single high wattage chips used in the Go Grow LED fixtures are new and improved within the industry. We believe many of the existing and future manufacturers of LED grow lights will eventually recognize the inherent flaws in using the small LED chip design and evolve towards using the single high wattage LED chips. Since Go Grow LED has been proactive in its research and testing of LED grow lights and improved upon existing products, we would like to secure our position as a technological leader and protect our products.
$$\frac{Energy Produced by}{1 square meter = σ {T}^{4}}$$
$$\frac{Total Square Meters}{\underline{A = 4 π {R}^{2}}}$$
$$\frac{Total Energy Produced}{\underline{L = ( 4 π {R}^{2} ) ( σ {T}^{4} )}}$$
